(19) United States
(12) Patent Application Publication
(10) Pub. No.: US 2014/0339876 A1
(43) Pub. Date: Nov. 20, 2014

(54) ARMREST EXTENSIONS FOR VEHICLES

(71) Applicant: Troy Edward Kisner, Poplar Bluff, MO (US)

(72) Inventor: Troy Edward Kisner, Poplar Bluff, MO (US)

(21) Appl. No.: 14/276,731

(22) Filed: May 13, 2014

Related U.S. Application Data
(60) Provisional application No. 61/855,420, filed on May 15, 2013.

(51) Int. Cl. B60N 2/46

(52) U.S. Cl. CPC B60N 2/4673
USPC 297/411.23

(57) ABSTRACT

An armrest extension is provided to extend a length of an existing armrest of a seat. In so doing, the armrest extension provides additional support to a user's arm, beyond the existing armrest. In addition, the armrest extension can be coupled to either a right or left armrest of the seat. And, after being installed to an existing armrest of a seat, the armrest extension can be removed from the armrest and moved to the other armrest of the seat, or moved to an armrest of another seat.

### CROSS-REFERENCE TO RELATED APPLICATION

This application claims the benefit of and priority to U.S. Provisional Application No. 61/855,420, filed on May 15, 2013. The entire disclosure of the above application is incorporated herein by reference.

### FIELD

The present disclosure generally relates to armrests for vehicles and, more particularly, to armrest extensions for use in such vehicles, for example, that are configured to couple to existing armrests in the vehicles.

### BACKGROUND

This section provides background information related to the present disclosure which is not necessarily prior art.

Vehicles often include seats with armrests. The seats often include captain chairs or seats in the vehicles. And, the vehicles typically include, for example, trucks (e.g., semi-trucks, pick-up trucks, etc.), vans, recreation vehicles, etc.

### SUMMARY

This section provides a general summary of the disclosure, and is not a comprehensive disclosure of its full scope or all of its features.

Exemplary embodiments of the present disclosure are generally directed toward armrest extensions. The armrest extensions are configured to releasably couple to seats of vehicles to extend lengths of existing armrests of the seats (e.g., original equipment manufacturer (OEM) armrests of the seats, etc.). For example, in some aspects, the armrest extensions are configured for installation over the existing armrests of the seats to thereby provide extended armrest lengths to users of the vehicles (e.g., so that the armrests are closer to steering wheels of the vehicles, etc.). Such extended armrest lengths may help inhibit fatigue of the users when driving the vehicles (e.g., when users are driving the vehicles for long distances (e.g., truck drivers, etc.), etc.). In addition, in some aspects, the armrest extensions can be used on either right or left armrests of the seats (e.g., the armrest extensions are ambidextrous, etc.). And, the armrest extensions can be removed from the seats and moved to other armrests of the seats, or to other seats (e.g., the armrest extensions are portable, etc.) as desired.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an exemplary embodiment of an armrest extension according to the present disclosure;

FIG. 2 is a right side view of the armrest extension of FIG. 1, illustrating installation of the armrest extension to a right armrest of a vehicle seat;

FIG. 3 is the right side view of FIG. 2, with the armrest extension shown installed to the right armrest of the vehicle seat;

FIG. 4 is a left side view of the armrest extension of FIG. 4, illustrating installation of the armrest extension to a left armrest of a vehicle seat;

FIG. 5 is the left side view of FIG. 4, with the armrest extension shown installed to the left armrest of the vehicle seat;

FIG. 6 is a right side view of another exemplary embodiment of an armrest extension according to the present disclosure;

FIG. 7 is a perspective view of a rearward end portion of the armrest extension of FIG. 6;

FIG. 8 is a perspective view of another exemplary embodiment of an armrest extension according to the present disclosure;

FIG. 9 is a perspective view of another exemplary embodiment of an armrest extension according to the present disclosure;

FIG. 10 is a perspective view of still another exemplary embodiment of an armrest extension according to the present disclosure;

FIG. 11 is another perspective view of the armrest extension of FIG. 10; and

FIG. 12 is a perspective view of another exemplary embodiment of an armrest extension according to the present disclosure.

Corresponding reference numerals indicate corresponding parts throughout the several views of the drawings.

### DETAILED DESCRIPTION

Exemplary embodiments will now be described more fully with reference to the accompanying drawings.

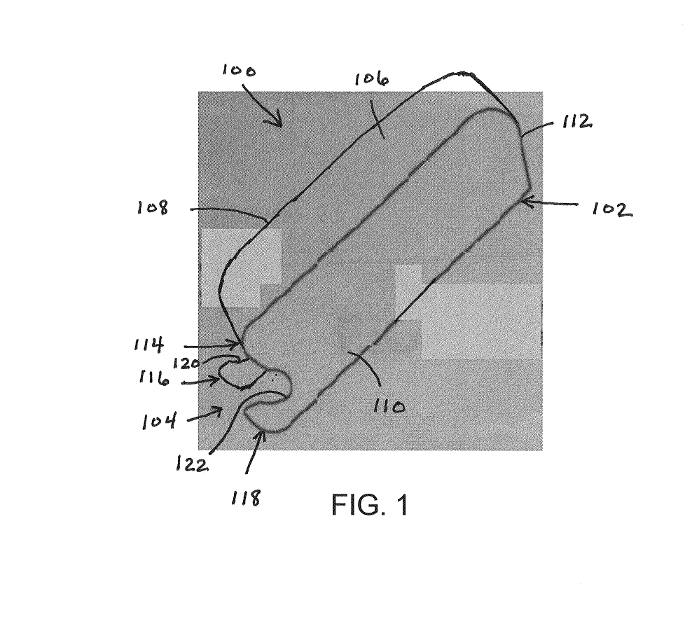

With reference now to the drawings, FIGS. 1-5 illustrate an exemplary embodiment of an armrest extension 100 according to the present disclosure. The armrest extension 100 is configured for installation over an existing armrest (e.g., an OEM armrest, etc.) of a seat. The armrest extension 100 can be installed over the armrest of any suitable seat including, for example, a captain seat, chair, etc. In addition, it should be appreciated that the armrest can be installed over either a right armrest of the seat or a left armrest of the seat (e.g., the armrest extension 100 is compatible with both the right and left armrests of the seat, the armrest extension 100 is interchangeable between the right and left armrests of the seat, the armrest extension 100 is ambidextrous, etc.). Further, it should also be appreciated that the armrest extension 100 can be used in any vehicle having a suitable seat, for example, a truck (e.g., a commercial truck, a semi-truck, a pick-up truck, etc.), a van, a recreational vehicle, a boat, etc.

As shown in FIG. 1, the armrest extension 100 generally includes a body 102, and a connector 104 located toward a rearward end portion of the body 102. The body 102 includes an upper surface 106, left and right side walls 108, 110, and a forward wall 112 (a bottom portion of the body is generally open). Together, the upper surface 106 and walls 108, 110, 112 generally define a channel 114 extending through the body 102. And, the connector 104 includes left and right hooks 116, 118, having a generally up-turned configuration. The rearward portion of the body 102 is generally open, such that the left and right hooks 116, 118 are defined in the left and right side walls 108, 110 of the body 102, respectively. With that said, the body 102 of the armrest can be constructed from any suitable material (e.g., metals, plastics, combinations thereof, etc.) and can have any suitable shape (e.g., a uniform shape, a shape that tapers or widens or flares from front to back, etc.). In addition, the body 102 of the armrest extension 100 can have any suitable size (e.g., a length of about 18 inches, a length greater than about 18 inches, a length less than about 18 inches, etc.) within the scope of the present disclosure.

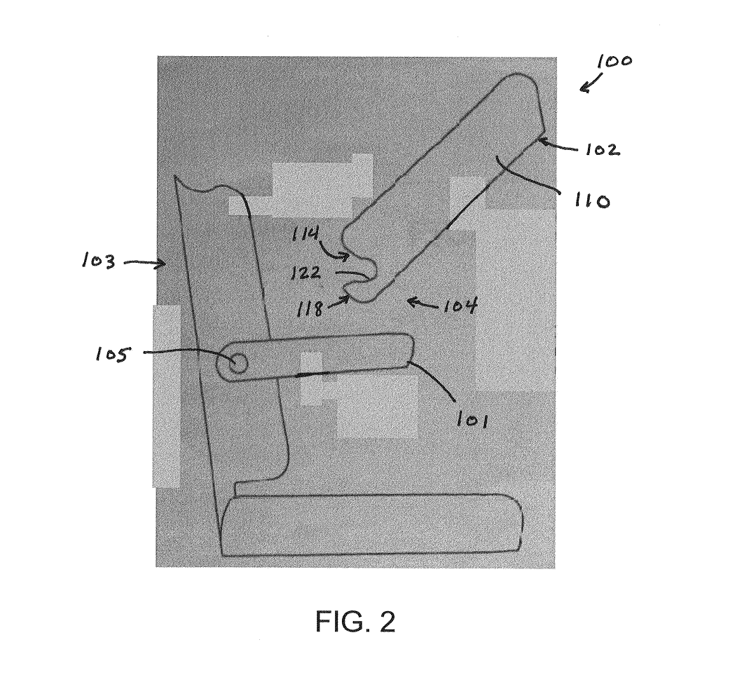

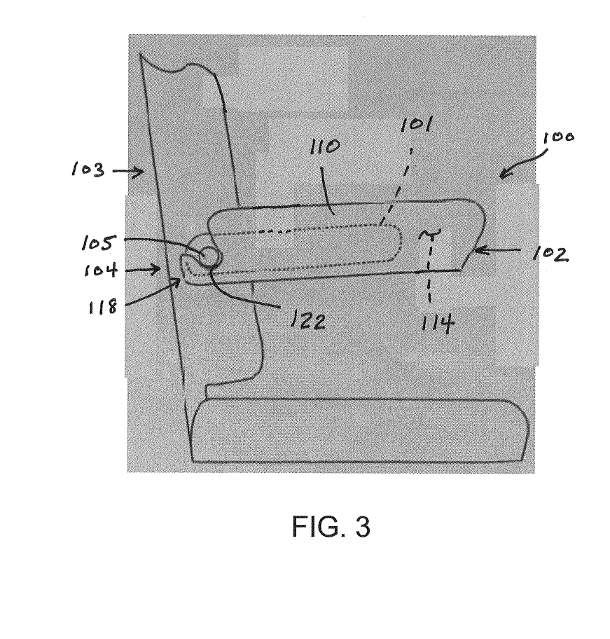

FIGS. 2 and 3 illustrate installation of the armrest extension 100 to a right armrest 101 of a seat 103 of a vehicle (e.g., the right OEM armrest provided with the seat 103, etc.). Initially, the armrest extension 100 is oriented at an angle (FIG. 2) to allow positioning of the armrest extension 100 over the armrest 101 (via the rearward open end portion), and positioning of the left hook 116 of the connector 104 under an armrest mounting pin 105 of the seat 103 (mounting the right armrest 101 to the seat 103). In so doing, the mounting pin 105 is located generally within an opening 120 (e.g., a slot, etc.) of the left hook 116 (e.g., a “C” shape opening, etc.). The armrest extension 100 is then rotated onto the armrest 101, and into the channel 114 of the armrest extension 100 (e.g., the armrest extension 100 slides over the existing armrest 101, etc.) (FIG. 3). The narrow left side wall 108 of the armrest extension 100 slips between a side of the armrest 101 and a side of the seat 103 adjacent the mounting pin 105.

Once installed to the seat 103, the armrest extension 100 substantially covers the armrest 101, and provides additional length to support a user's arm, for example, closer to a steering wheel while driving the vehicle (e.g., an entire length of the user's arm instead of just a portion of a forearm, a portion of the users arm closer to a steering wheel of the vehicle, etc.). The additional support provided by the armrest extension 100 can help inhibit fatigue in the back, shoulders, arms, etc. of the user, especially during long trips in which the user may hold the steering wheel for prolonged periods of time (as compared to just the armrest 101). In addition, the armrest extension 100 fits snugly over the armrest 101, and the mounting pin 105 fits, rests, locks, etc. in the opening 120 of the left hook 116 to thereby help inhibit unwanted movement of the armrest extension 100 (e.g., unwanted sliding movement of the armrest extension 100 when the user enters or exits the seat, etc.). The armrest extension 100 can then be removed from the armrest 101, when desired, by rotating it up and moving it forward to disengage the left hook 116 from the mounting pin 105.

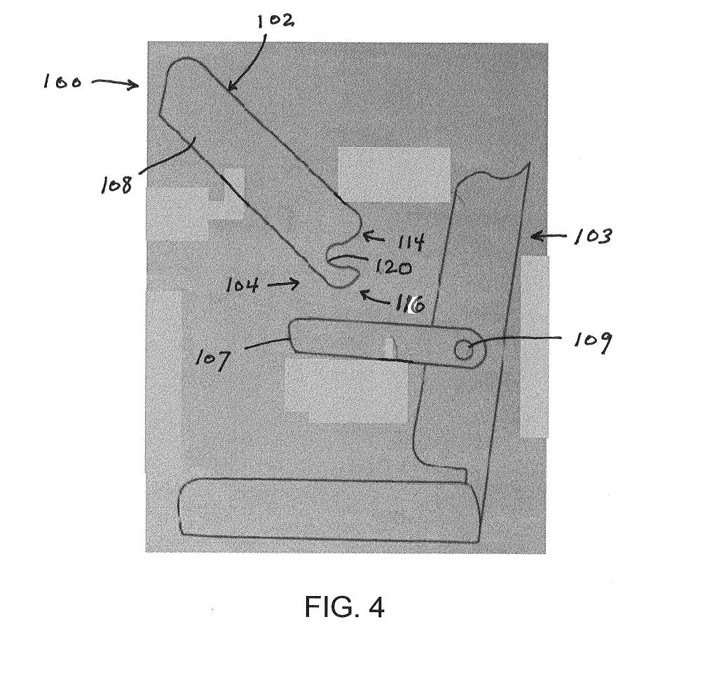

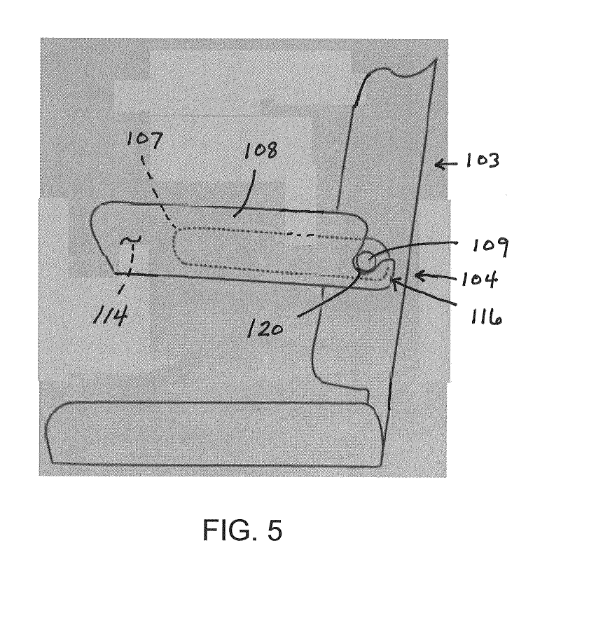

FIGS. 4 and 5 illustrate installation of the armrest extension 100 to a left armrest 107 of the seat 103 (e.g., the left OEM armrest provided with the seat, etc.). The armrest extension 100 is initially oriented at an angle (FIG. 4) to allow positioning of the armrest extension 100 over the armrest 107 (via the rearward open end portion), and positioning of the right hook 118 of the connector 104 under an armrest mounting pin 109 of the seat 103 (mounting the left armrest 107 to the seat 103). In so doing, the mounting pin 109 is located generally within an opening 122 (e.g., a slot, etc.) of the right hook 118 (e.g., a “C” shape opening, etc.). The armrest extension 100 is then rotated onto the armrest 107, and into the channel 114 of the armrest extension 100 (FIG. 5). The narrow right side wall 110 of the armrest extension 100 slips between a side of the armrest 107 and a side of the seat 103 adjacent the mounting pin 109. Once installed, the armrest extension 100 again substantially covers the armrest 107, and provides additional length to support a user's arm. And, the armrest extension 100 fits snugly over the armrest 107, and the mounting pin 109 fits, rests, locks, etc. in the opening 122 of the right 118 hook to thereby help inhibit unwanted movement of the armrest extension 100.

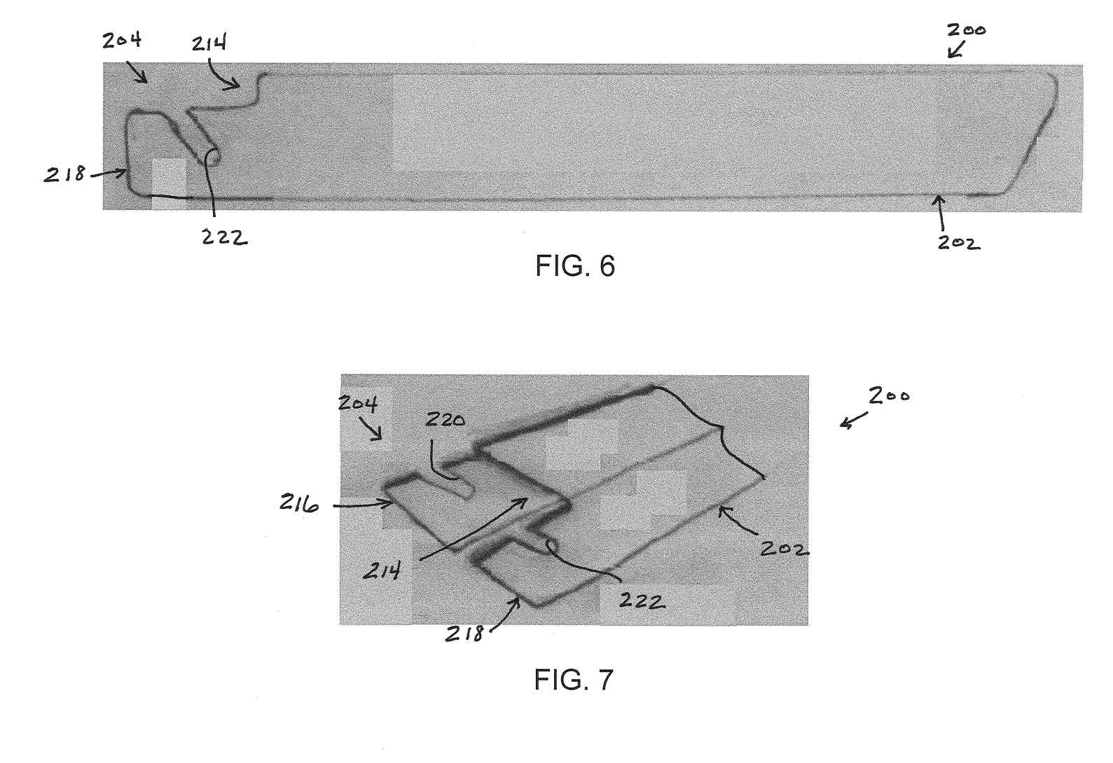

FIGS. 6 and 7 illustrate another exemplary embodiment of an armrest extension 200 according to the present disclosure. The armrest extension 200 is again configured for installation over an existing armrest of a seat (e.g., of a vehicle, etc.), and can be installed over either a right armrest or a left armrest of the seat.

The armrest extension 200 of this embodiment is substantially similar to the armrest extension 100 previously described and illustrated in FIGS. 1-5. For example, the armrest extension generally includes a body 202 defining a channel 214, and a connector 204 located toward a rearward end portion of the body 202. In this embodiment, however, the connector 204 includes left and right hooks 216, 218 defining generally upwardly extending slots 220, 222 (e.g., “U” shape openings, etc.). As such, when the armrest extension 200 is installed over an armrest of a seat (e.g., a right armrest or a left armrest), and an armrest mounting pin of the seat is positioned generally within the corresponding slot 220, 222, the upward orientation of the slot 220, 222 helps hold the mounting pin in the slot 220, 222 and helps inhibit unwanted movement of the armrest extension 200 (e.g., unwanted sliding movement of the armrest extension 200 when the user enters or exits the seat, etc.). In the illustrated embodiment, each slot 220, 222 is oriented generally upwardly, relative to a longitudinal axis of the armrest extension 200, at an angle of about 45 degrees. However, in other embodiments, each slot 220, 222 may be oriented at other angles such as, for example, about 20 degrees, about 30 degrees, about 40 degrees, about 50 degrees, about 60 degrees, about seventy degrees, at angles there between, etc.

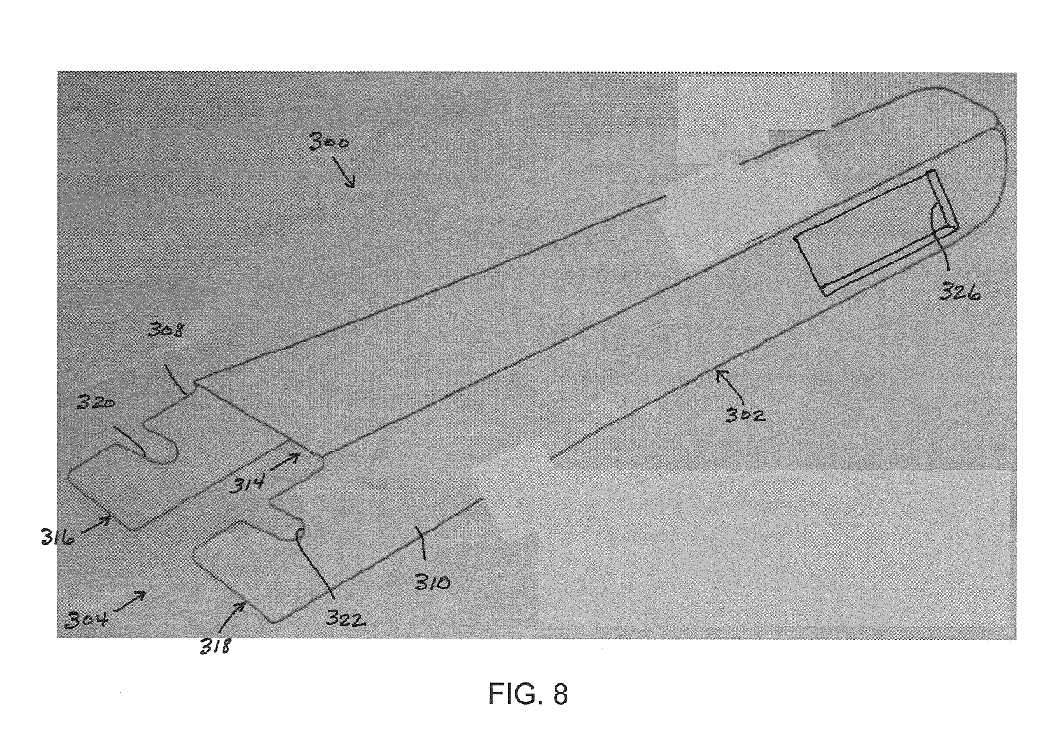

FIG. 8 illustrates another exemplary embodiment of an armrest extension 300 according to the present disclosure. The armrest extension 300 is again configured for installation over an existing armrest of a seat (e.g., of a vehicle, etc.), and can be installed over either a right armrest or a left armrest of the seat.

The armrest extension 300 of this embodiment is substantially similar to the armrest extension 100 previously described and illustrated in FIGS. 1-5. For example, the armrest extension 300 generally includes a body 302 defining a channel 314, and a connector 304 located toward a rearward end portion of the body 302. In addition in this embodiment, the connector 304 of the armrest extension 300 includes left and right hooks 316, 318 each defining a generally upwardly extending slot 320, 322 similar to the armrest extension 200 previously described and illustrated in FIGS. 6 and 7.

In this embodiment, the armrest extension 300 further includes an opening 326 (e.g., a pocket, etc.) defined in a right side wall 310 of the body 302 for holding desired items in the armrest extension 300. The opening 326 is easily accessible to a user while using the armrest extension 300, and provides a convenient place to store the desired items (while keeping them close at hand if needed). In the illustrated embodiment, the opening 326 defines a generally rectangular shape and may be used to hold a cell phone, an iPod, or other similarly sized devices. As such, the opening 326 allows the user to keep the devices close while they are charging or in use (e.g., while talking on the cell phone using Bluetooth®, etc.). In other embodiments, the opening 326 may be shaped differently, for example, to hold other desired items (e.g., wallets etc.). In addition, a cover, resilient fingers, or other device may also be associated with the opening 326 to help secure and/or retain the items in the opening 326 (e.g., against inadvertently falling out, etc.). With that said, it should be appreciated that the opening 326 could alternatively be located in a left side wall 308 of the body 302, or openings 326 could be located in both side walls 308, 310 of the body 302.

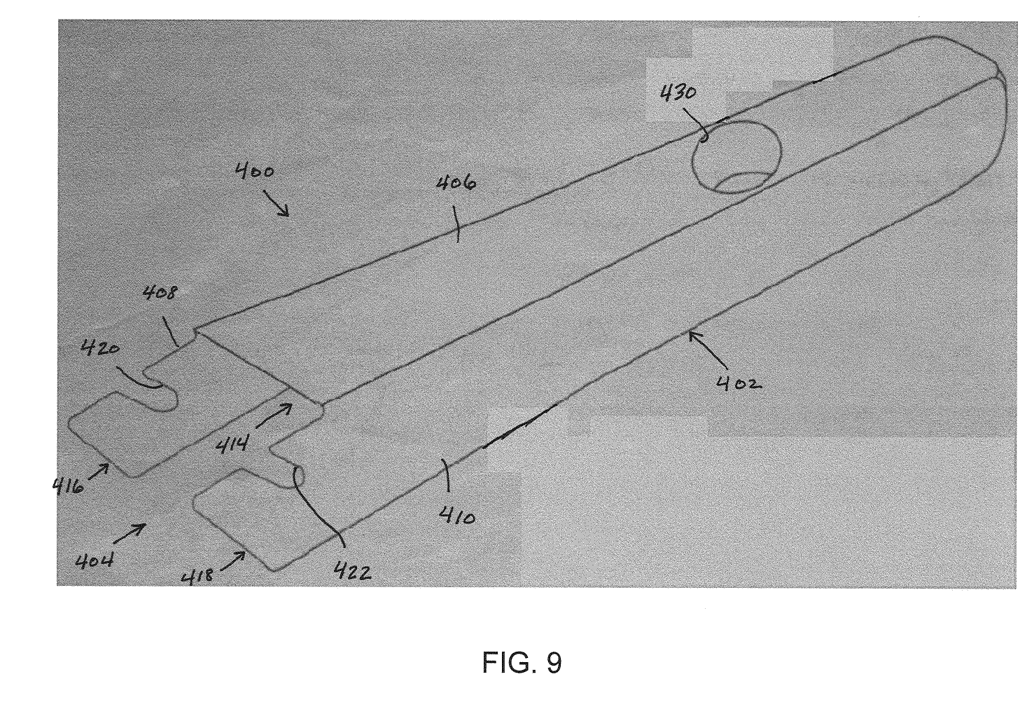

FIG. 9 illustrates another exemplary embodiment of an armrest extension 400 according to the present disclosure. Again, the armrest extension 400 is configured for installation over an existing armrest of a seat (e.g., of a vehicle, etc.), and can be installed over either a right armrest or a left armrest of the seat.

The armrest extension 400 of this embodiment is substantially similar to the armrest extension 100 previously described and illustrated in FIGS. 1-5. For example, the armrest extension 400 generally includes a body 402 defining a channel 414, and a connector 404 located toward a rearward end portion of the body 402. In addition in this embodiment, the connector 404 of the armrest extension 400 includes left and right hooks 416, 418 each defining a generally upwardly extending slot 420, 422 similar to the armrest extension 200 previously described and illustrated in FIGS. 6 and 7.

In this embodiment, the armrest extension 400 further includes an opening 430 defined in an upper surface 406 of the body 402. The opening 406 may be used for holding a beverage container or any other desired items (e.g., change, turn pike tickets, etc.) in the armrest extension 400, to facilitate easy and convenient access to the beverage or other items. In the illustrated embodiment, the opening 430 defines a generally circular shape, but may define other shapes in other embodiments. In addition, in other embodiments, similar holders may be separately coupled to the armrest extension 400 as desired (e.g., to left and/or right side walls 408 and/or 410 of the body 402, etc.), or may even be integral with the armrest extension 400 and, for example, selectively retractable into the armrest extension 400 when desired (e.g., when not in use, etc.).

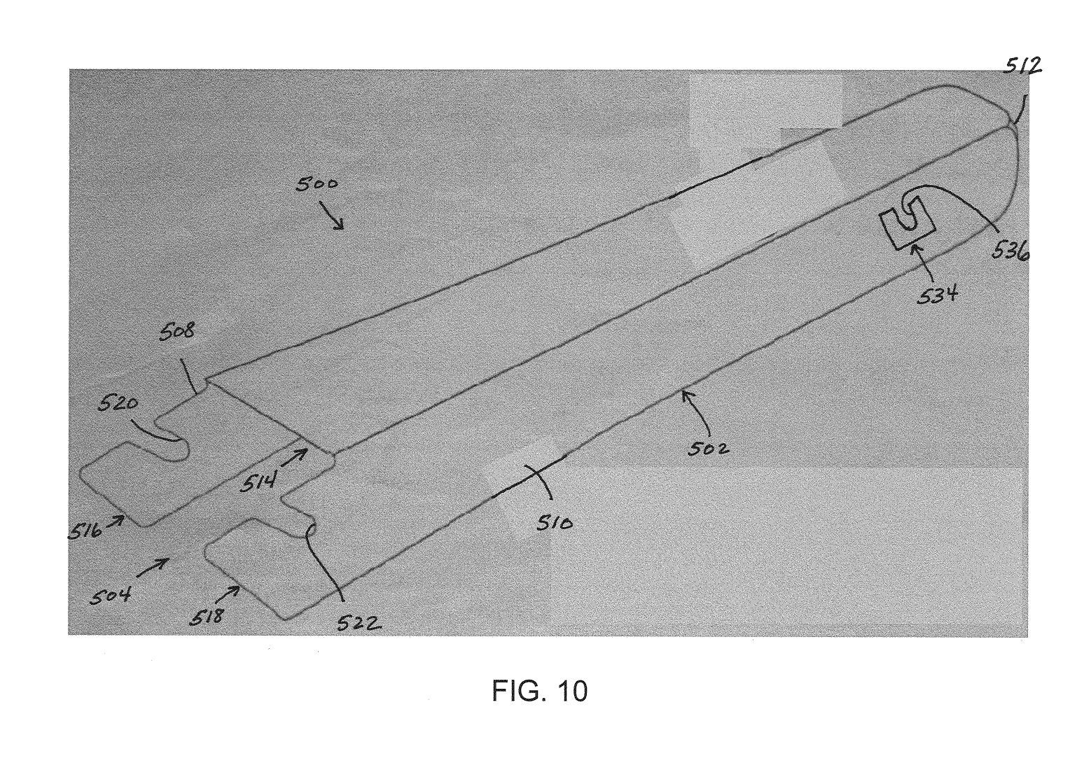

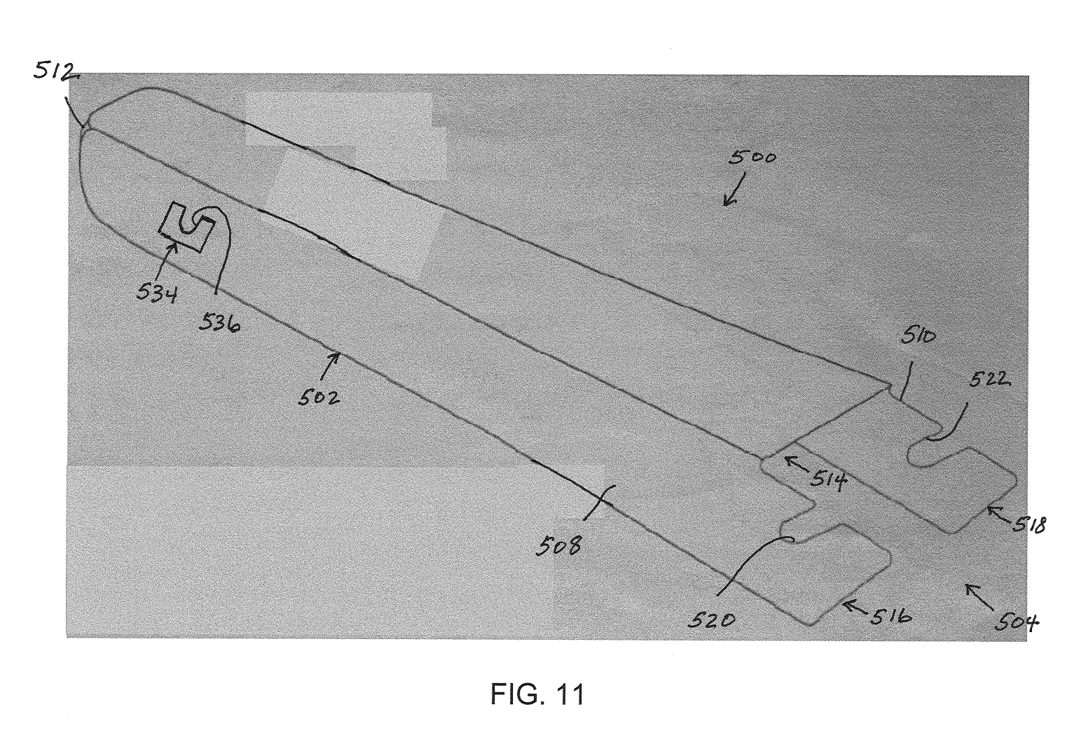

FIGS. 10 and 11 illustrate another exemplary embodiment of an armrest extension 500 according to the present disclosure. The armrest extension 500 is again configured for installation over an existing armrest of a seat (e.g., of a vehicle, etc.), and can be installed over either a right armrest or a left armrest of the seat.

The armrest extension 500 of this embodiment is substantially similar to the armrest extension 100 previously described and illustrated in FIGS. 1-5. For example, the armrest extension 500 generally includes a body 502 defining a channel 514, and a connector 504 located toward a rearward end portion of the body 502. In addition in this embodiment, the connector 504 of the armrest extension includes left and right hooks 516, 518 each defining a generally upwardly extending slot 520, 522 similar to the armrest extension 200 previously described and illustrated in FIGS. 6 and 7.

In this embodiment, the armrest extension 500 further includes mounts 534 positioned on left and right side walls 508, 510 of the body 502 for holding a radio microphone (e.g., a CB radio microphone, etc.). The illustrated mounts 534 each define a generally “U” shaped slot 536 for receiving a corresponding clip of the radio microphone and mounting the radio microphone to the armrest extension 500. In other embodiments, the mounts 534 may define other shapes, for example, generally “V” shapes, etc. In addition, it should be appreciated that the mounts 534 may be coupled to the side walls 508, 510 of the body 502, or formed uniformly therewith, or the mounts 534 may even be located on other parts of the armrest extension 500. For example, a mount 534 may be located on a forward wall 512 of the body 502 of the armrest extension 500 (in addition to the mounts 534 located on the side walls 508, 510, or instead of the mounts 534 located on the side walls 508, 510) Further, in other embodiments, armrest extensions may include only one mount located on either right side walls or left side walls.

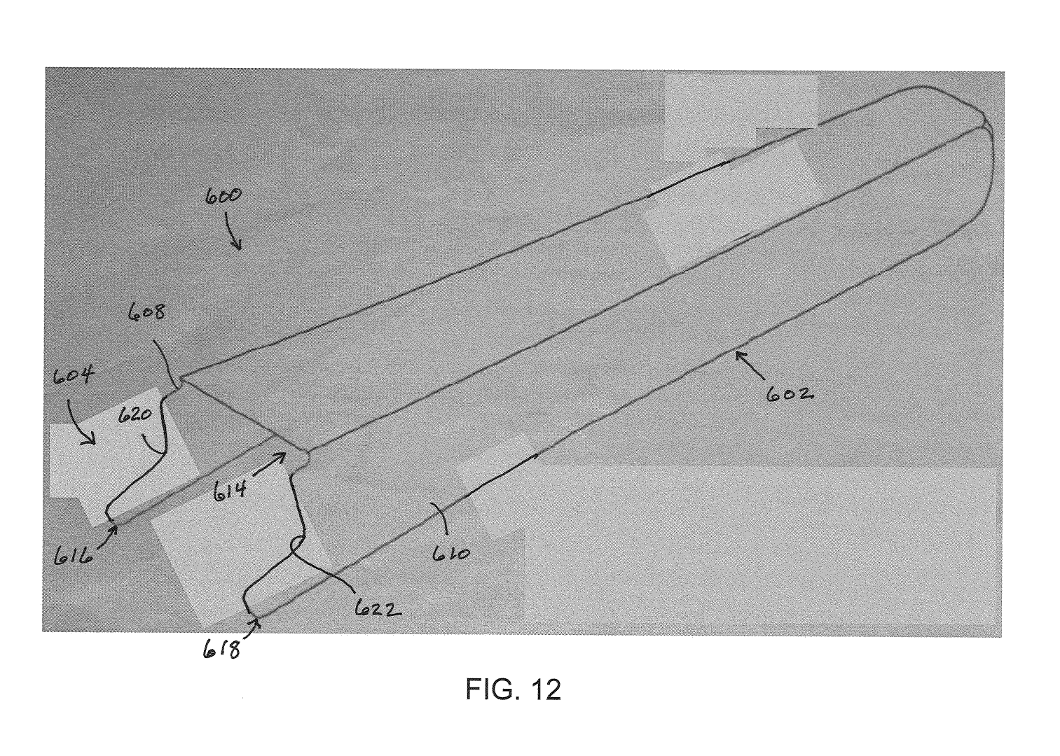

FIG. 12 illustrates another exemplary embodiment of an armrest extension 600 according to the present disclosure. The armrest extension 600 is again configured for installation over an existing armrest of a seat (e.g., of a vehicle, etc.), and can be installed over either a right armrest or a left armrest of the seat.

The armrest extension 600 of this embodiment is substantially similar to the armrest extension 100 previously described and illustrated in FIGS. 1-5. For example, the armrest extension 600 generally includes a body 602 defining a channel 614, and a connector 604 located toward a rearward end portion of the body 602. In this embodiment, the connector 604 includes left and right arms 616, 618 extending rearwardly of the armrest extension 600 (e.g., as part of left and right side walls 608, 610). The illustrated arms 616, 618 do not include upturned portions, and openings 620, 622 defined by the arms 616, 618 (for receiving mounting pins of existing seat armrests) extend rearwardly of the armrest extensions in a generally horizontal orientation.

As can be seen, exemplary embodiments of the armrest extensions are separate components from seats, and can be easily installed thereto, for example, as aftermarket products, etc. In addition, exemplary embodiments of the armrest extensions can be removably installed to the armrests of the seats, so that they can be subsequently removed and transferred to other armrests of the same seats (e.g., where the armrest extensions are ambidextrous, etc.) or to armrests of other seats (e.g., in other vehicles, etc.).

In still other exemplary embodiments, armrest extensions may include padding along at least part of upper surfaces, to provide comfort to users when resting arms on the armrest extensions.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that exemplary embodiments may be embodied in many different forms, and that neither should be construed to limit the scope of the disclosure. In some exemplary embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally,” “about,” and “substantially,” may be used herein to mean within manufacturing tolerances. Whether or not modified by the term “about,” the claims include equivalents to the quantities.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the exemplary embodiments.

Spatially relative terms, such as “inner,” “outer,” “beneath,” “below,” “lower,” “above,” “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An armrest extension for a seat of a vehicle, the armrest extension comprising a connector for receiving a mounting pin of the seat, located along a left side portion of the seat, for thereby coupling the armrest extension to the seat along the left side portion of the seat.

2. The armrest extension of claim 1, wherein the connector includes an opening defined in a right side wall portion of the armrest extension for receiving the mounting pin of the seat.

3. The armrest of claim 2, wherein the opening defines an elongate slot oriented at an angle of between about 20 degrees and about 70 degrees relative to a longitudinal axis of the armrest extension.

4. The armrest of claim 2, wherein the opening defines an elongate slot oriented at an angle of between about 35 degrees and about 55 degrees relative to a longitudinal axis of the armrest extension.

5. The armrest of claim 2, wherein the opening defines an elongate slot oriented at an angle of about 45 degrees relative to a longitudinal axis of the armrest extension.

6. The armrest extension of claim 1, wherein the connector includes a hook defined in a right side wall portion of the armrest extension, the hook configured to extend at least partially around the mounting pin of the seat when the armrest extension is coupled to the seat.

7. The armrest extension of claim 6, wherein the hook is configured to extend at least partially under the mounting pin of the seat when the armrest extension is coupled to the seat.

8. The armrest extension of claim 1, further comprising a mount disposed on the armrest extension for coupling a radio microphone to the armrest extension.

9. The armrest extension of claim 8, wherein the mount defines a slot opening for receiving a portion of the radio microphone therein, for coupling the radio microphone to the armrest extension.
